(19) United States
(12) Patent Application Publication
(10) Pub. No.: US 2016/0272822 A1
(43) Pub. Date: Sep. 22, 2016

(54) MATERIAL COMPOSITION AND METHOD FOR LASER ABLATION

(71) Applicant: GM GLOBAL TECHNOLOGY OPERATIONS LLC, Detroit, MI (US)

(72) Inventors: Bruce N. Greve, Clarkston, MI (US); Saul S. Lee, Franklin, MI (US); Christopher G. Basela, Ortonville, MI (US); Pamela L. Mabery, Lake Orion, MI (US); John F. Cantalin, JR., Rochester Hills, MI (US)

(73) Assignee: GM GLOBAL TECHNOLOGY OPERATIONS LLC, Detroit, MI (US)

(21) Appl. No.: 14/663,856

(22) Filed: Mar. 20, 2015

(51) Int. Cl. C09D 5/32; B29C 65/16; B62D 29/00

(52) U.S. Cl. CPC C09D 5/32; B62D 29/00; B29C 65/16; B29L 2031/30

(57) ABSTRACT

A material composition and a method are provided for improved laser ablation of a surface portion of a part made from the material composition. The material composition includes an additive having known electromagnetic energy absorption characteristics for enhancing energy transfer from a laser beam to the surface portion of the part. The laser beam may have a primary electromagnetic wavelength. The additive may absorb energy at the primary electromagnetic wavelength to enhance energy transfer from the laser beam to the surface portion of the part.

### TECHNICAL FIELD

This disclosure relates to a material composition and method for improved laser ablation.

### BACKGROUND

A vehicle or a structure may include a part that is attached to another part or coated with a coating material via a bond. The bond may be an adhesive bond, a coating material bond, or a weld bond. The part may be made of a composite material, such as a glass or carbon fiber reinforced plastic, or may be made of a filled or unfilled plastic material. Laser ablation has been found to be an effective pretreatment to prepare the surface of many materials, including composite and plastic materials, for bonding. Laser ablation uses the energy from a laser beam to vaporize a thin surface portion of the part or to remove contaminates on the surface of the part in order to expose an uncontaminated and/or roughened surface for bonding. However, some composite and plastic materials are partially or completely transparent to the electromagnetic radiation wavelength of the laser beam.

### SUMMARY

A material composition, a vehicle, and a method are disclosed herein. The material composition is for improved laser ablation of a surface portion of a part made from the material composition. The material composition includes an additive having known electromagnetic energy absorption characteristics for enhancing energy transfer from a laser beam to the surface portion of the part. The laser beam may have a primary electromagnetic wavelength. The additive may absorb electromagnetic energy at the primary electromagnetic wavelength to enhance energy transfer from the laser beam to the surface of the part.

The vehicle includes a part made of a material composition that has a laser ablated surface that is bonded. The material composition includes an additive having known electromagnetic energy absorption characteristics for enhancing energy transfer from a laser beam to a surface portion of the part. The laser beam may have a primary electromagnetic wavelength. The additive may absorb electromagnetic energy at the primary electromagnetic wavelength to enhance energy transfer from the laser beam to the surface portion of the part. The vehicle may include a second part. The laser ablated surface may be bonded to the second part via an adhesive. The laser ablated surface may be bonded to the second part via a weld. The vehicle may include a surface coating material. The laser ablated surface may be bonded to and coated with the surface coating material.

The method includes adding an additive to a material that absorbs electromagnetic energy at a predetermined electromagnetic wavelength; laser ablating a surface of the material with a laser beam having the predetermined electromagnetic wavelength to vaporize a surface portion of the material to expose an uncontaminated and/or roughened surface of the material for bonding; and bonding the material at the uncontaminated and/or roughened surface.

The material composition, vehicle, and method for improved laser ablation of a surface portion of a part may provide enhanced energy transfer from the laser beam to the surface portion of the part. Enhanced energy transfer may result in reduced laser energy requirements and more consistent laser ablation. This disclosure applies to laser ablation of any part, in any machine or manufacture, made of any material, for any purpose.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a fragmentary, schematic, perspective, exploded view illustration of a vehicle having a part that has a laser ablated surface that is bonded and is made of a material composition that includes an additive for enhancing energy transfer from a laser beam to a surface portion of the part.

FIG. 2 is a fragmentary, schematic, perspective, exploded view illustration of the vehicle of FIG. 1, viewed in the direction of arrow 2 of FIG. 1, showing the laser ablated surface of the part in greater detail.

FIG. 3 is a fragmentary, schematic, cross sectional illustration of the part of FIG. 2 as the laser ablated surface is being created by a laser device.

FIG. 4 is a flowchart of a method for bonding a material.

### DETAILED DESCRIPTION

Referring to the drawings, wherein like reference numbers refer to like components throughout the views, FIG. 1 shows a vehicle 10 including body 12 and a part 14. The part 14 may be a tail lamp panel, as shown, or may be any other part of the vehicle 10, as understood by those skilled in the art. Nonlimiting examples include a rear surround panel or second part 16, a rear compartment panel 18, a floor panel 20, a door surround panel 22, a dash panel 24, a motor compartment panel 26, and a frame 28.

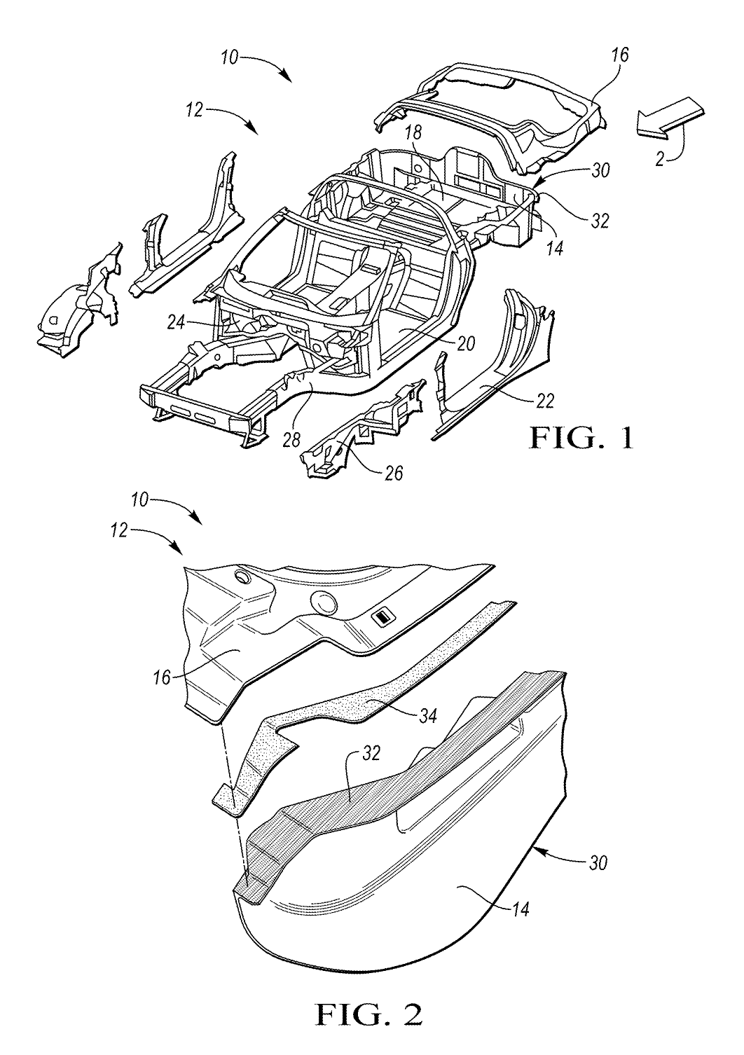

Referring now to FIG. 2, the part 14 is made of a material composition 30 and has a laser ablated surface 32, to be explained in detail below. The laser ablated surface 32 of the part 14 may be bonded to the second part 16 or may be bonded to a coating material (not shown). The bond may be an adhesive bond, as shown, where the part 14 is bonded to the second part 16 via an adhesive 34. The bond may be a coating material bond (not shown), where the coating material is bonded to the part 14 and coats the part 14, or the bond may be a weld bond (not shown), where the part 14 is fused to the second part 16 or to an added weld material (not shown). The second part 16 may also have a laser ablated surface 32 that may be bonded to the first part 14 or to a coating material (not shown).

The material composition 30 may be a composite material or a plastic material. Nonlimiting examples of the composite material include a glass fiber reinforced thermoset plastic, such as a sheet molding compound, a glass fiber reinforced thermoplastic material, a carbon fiber reinforced thermoset plastic, and a carbon fiber reinforced thermoplastic material. Nonlimiting examples of the plastic material include a filled thermoset plastic, a filled thermoplastic material, an unfilled thermoset plastic, and an unfilled thermoplastic material. The material composition 30 may also be a rubber material, a ceramic material, a metal material, and/or any other suitable material, and may be unfilled, filled, and/or reinforced as appropriate.

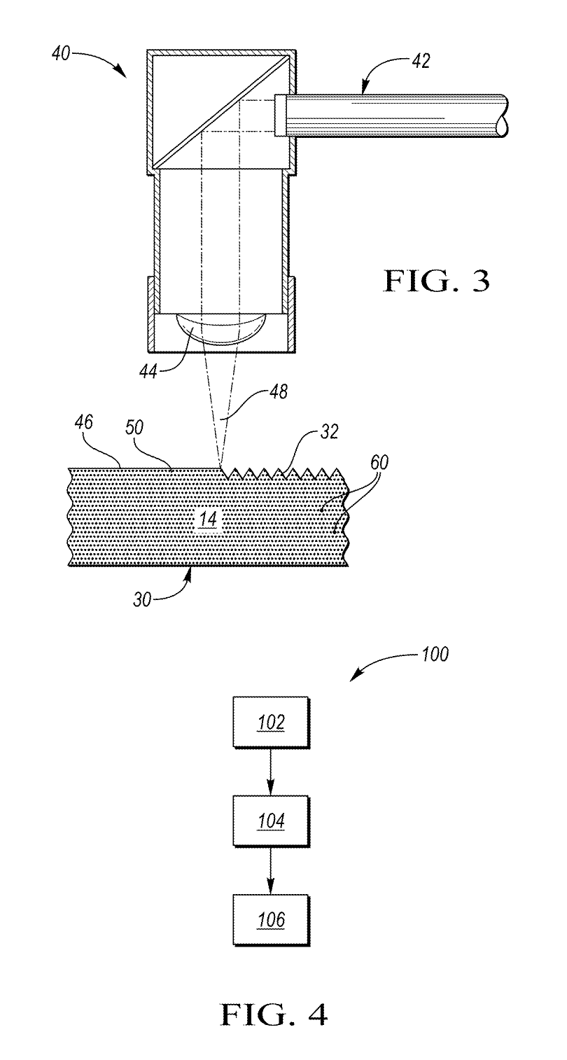

Referring now to FIG. 3, laser ablation of the part 14 is accomplished with a laser ablation system 40. The laser ablation system 40 includes a laser device 42 having focusing optics 44 and a means of moving the laser device 42 over a surface 46 of the part 14. The focusing optics 44 may include a lens, as shown, or may include any other focusing device. The laser device 42 emits a focused laser beam 48. The laser device 42 may be a fiber optic laser device, as shown, or any other laser device, as understood by those skilled in the art. The means of moving the laser device 42 over the surface 46 of the part 14 may be a robot, a machine, or any other suitable means of moving the laser device 42 over the surface 46 of the part 14.

Laser ablation is accomplished by moving the laser device 42, and hence the focused laser beam 48, over the surface 46 of the part 14 at a predetermined speed on a predetermined path in two or three dimensional space, depending on the shape of the part 14, the power and the electromagnetic radiation wavelength of the laser beam 48, the focusing optics 44, and other factors. The electromagnetic energy or electromagnetic radiation of the laser beam 48 is absorbed by a thin surface portion 50 of the part 14. The absorbed energy of the laser beam 48 vaporizes the thin surface portion 50 of the part 14 and/or removes contaminates on the surface 46 of the part 14 to expose an uncontaminated and/or roughened, laser ablated surface 32 for bonding. Vaporize is defined herein as to convert by the application of heat into diffused matter suspended in the air. Some composite, plastic, and other materials are partially or completely transparent to the electromagnetic radiation wavelength of the laser beam 48.

The material composition 30 for improved laser ablation of the part 14 includes an additive 60 having known electromagnetic energy absorption characteristics for enhancing energy transfer from the laser beam 48 to the thin surface portion 50 of the part 14. The additive 60 is mixed into the material composition 30 before the part 14 is formed. The additive 60 may be chemically bonded to the material composition 30. The laser beam 48 may have a primary electromagnetic wavelength, which may include most of the electromagnetic energy of the laser beam 48. The additive 60 absorbs electromagnetic energy at the primary electromagnetic wavelength to enhance energy transfer from the laser beam 48 to the surface portion 50 of the part 14.

The primary electromagnetic wavelength of the laser beam 48 may be in a range of electromagnetic wavelengths of about 150 nm to 1 mm. The primary electromagnetic wavelength of the laser beam 48 may be in an ultraviolet (UV) electromagnetic wavelength range of about 150 nm to 400 nm, in a visible electromagnetic wavelength range of about 400 nm to 700 nm, or in an infrared (IR) electromagnetic wavelength range of about 700 nm to 1 mm.

The additive 60 may be one of a dye, a pigment, and a chemical functional group that absorbs energy in the electromagnetic wavelength range of about 150 nm to 1 mm. The dye and the pigment may be either organic or inorganic. A dye is defined as a chemical element or a chemical compound that is soluble and has an affinity to the material composition 30. A pigment is defined as a chemical element or a chemical compound that is insoluble and has no affinity to the material composition 30. A chemical functional group is defined as an organic chemical compound that may be chemically bonded to a polymer chain of the material composition 30. More than one additive 60 that absorbs energy in the electromagnetic wavelength range of about 150 nm to 1 mm may be included in the material composition 30.

Nonlimiting examples of dyes and pigments having known electromagnetic energy absorption characteristics and effective in absorbing energy in the electromagnetic wavelength range of about 150 nm to 1 mm follow. Azobenzene derived azo dyes have been found to be effective in the UV electromagnetic wavelength range. Rhodamine B, coumarin, fluorescein, and rhodamine 6G have been found to be effective in the visible electromagnetic wavelength range. Carbon black and iron oxide derived pigments have been found to be effective in the IR electromagnetic wavelength range. Nonlimiting examples of chemical functional groups having known electromagnetic energy absorption characteristics and effective in absorbing energy in the electromagnetic wavelength range of about 150 nm to 1 mm include aromatic groups, conjugated alkenes, aldehydes/ketones, amino groups, and alcohols.

Referring now to FIG. 4, an example method 100 for bonding a material 30, as described above, includes the following steps, in sequence. At step 102, an additive 60, as described above, is added to the material 30. The additive 60 absorbs electromagnetic energy having a predetermined electromagnetic wavelength. At step 104, a surface 46 of the material 30 is laser ablated, as described above, with a laser beam 48 having the predetermined electromagnetic wavelength to vaporize a surface portion 50 of the material 30 in order to expose an uncontaminated and/or roughened surface 32 of the material 30 for bonding. At step 106, the material 30 is bonded at the uncontaminated and/or roughened surface 32.

As described above, bonding may be via an adhesive 34, via a weld that fuses the material 30 to another material, and/or via a surface coating material that coats and bonds to the uncontaminated and/or roughened surface 32 of the material 30.

This disclosure applies to laser ablation of any part, in any machine or manufacture, made of any material, for any purpose.

While the best modes for carrying out the many aspects of the present teachings have been described in detail, those familiar with the art to which these teachings relate will recognize various alternative aspects for practicing the present teachings that are within the scope of the appended claims.

1. A material composition for a part to improve laser ablation of a surface portion of the part, the material composition comprising:
an additive having known electromagnetic energy absorption characteristics for enhancing energy transfer from a laser beam to the surface portion of the part.

2. The material composition of claim 1, wherein the laser beam has a primary electromagnetic wavelength; and
wherein the additive absorbs energy at the primary electromagnetic wavelength to enhance energy transfer from the laser beam to the surface portion of the part.

3. The material composition of claim 2, wherein the primary electromagnetic wavelength is between about 150 nm to 1 mm.

4. The material composition of claim 1, wherein the additive is a dye.

5. The material composition of claim 1, wherein the additive is a pigment.

6. The material composition of claim 1, wherein the additive is a chemical functional group.

7. The material composition of claim 1, further comprising a primary material; wherein the primary material is a composite material.

8. The material composition of claim 1, further comprising a primary material; wherein the primary material is a plastic material.

9. A vehicle, comprising:
a part made of a material composition and having a laser ablated surface that is bonded;
wherein the material composition includes an additive having known electromagnetic energy absorption characteristics for enhancing energy transfer from a laser beam to a surface portion of the part.

10. The vehicle of claim 9, wherein the laser beam has a primary electromagnetic wavelength; and
wherein the additive absorbs energy at the primary electromagnetic wavelength to enhance energy transfer from the laser beam to the surface portion of the part.

11. The vehicle of claim 10, wherein the primary electromagnetic wavelength is between about 150 nm to 1 mm.

12. The vehicle of claim 9, wherein the material composition further includes a primary material; and wherein the primary material is a composite material.

13. The vehicle of claim 9, wherein the material composition further includes a primary material; and wherein the primary material is a plastic material.

14. The vehicle of claim 9, further comprising a second part;
wherein the laser ablated surface is bonded to the second part via an adhesive.

15. The vehicle of claim 9, further comprising a second part;
wherein the laser ablated surface is bonded to the second part via a weld.

16. The vehicle of claim 9, further comprising a surface coating material;
wherein the laser ablated surface is bonded to the surface coating material.

17. A method for bonding a material, the method comprising in sequence:
adding an additive to the material that absorbs electromagnetic energy having a predetermined wavelength;
laser ablating a surface of the material with a laser beam having the predetermined wavelength to vaporize a surface portion of the material to expose an uncontaminated surface of the material for bonding; and
bonding the material at the uncontaminated surface.

18. The method of claim 17, wherein bonding is via an adhesive.

19. The method of claim 17, wherein bonding is via a weld.

20. The method of claim 17, wherein bonding is via a surface coating material.
